(19) United States
(12) Patent Application Publication
(10) Pub. No.: US 2022/0120424 A1
(43) Pub. Date: Apr. 21, 2022

(54) SURGE IMMUNE VERSATILE TERMINAL BLOCK ASSEMBLY

(71) Applicants: William Lorne Smith, Breslau (CA); Solomon Raju Stanley Chinnam, Austin, TX (US)

(72) Inventors: William Lorne Smith, Breslau (CA); Solomon Raju Stanley Chinnam, Austin, TX (US)

(21) Appl. No.: 17/505,510

(22) Filed: Oct. 19, 2021

Related U.S. Application Data
(60) Provisional application No. 63/093,674, filed on Oct. 19, 2020.

(51) Int. Cl. F21V 25/10; H02H 11/00; F21V 23/06

(52) U.S. Cl. CPC F21V 25/10; F21V 23/06; H02H 11/00

(57) ABSTRACT

In one embodiment of the present invention, there is described a surge immune terminal block assembly consisting of a terminal block comprised of a base housing unit and a surge protection housing unit, such that when the base housing unit and the surge protection housing unit are coupled together, the terminal block provides electrical connectivity and surge protection. Extruding from the body of the surge protection housing unit are polarity protected mechanical plugs that dock into corresponding cut-away portions in the base housing unit. When docked, the mechanical plugs connect with electrical terminations to provide an electrical connection between the electrical connectivity components of the base housing unit and the surge protection components.

### TECHNICAL FIELD

The present disclosure relates in general to the field of terminal blocks for use in lighting systems and more particularly to terminal blocks incorporating surge protection for use in lighting systems.

### BACKGROUND

For installation of light fixtures, known as luminaires, safety is a paramount consideration. Luminaires may go undergo significant stresses during their life cycle in the field and every component within the luminaire must be well secured for safety reasons. In particular, there must be proper installation of wire terminations associated with the luminaire system.

Luminaires are generally installed according to applicable standards. For instance, standards UL 1598 and UL 1059 require luminaires to use 18 AWG or higher gauge electrical wires in order to draw electric power from a utility power main.

Mains voltage can vary by application (for example commercial application may differ from roadway application) and can range from 120 Vac to 480 Vac in the U.S. UL 1059 provides specifications for terminal blocks to be used in certain luminaire environments. Terminal blocks are well known and are commonly used in many luminaire applications. UL 1059 specifies pole to pole placement and the wire gauge the terminal block must accept, as driven by NEC codes. UL 1059 further directs the minimum and maximum operational parameters and connection reliability for safe operation of terminal blocks.

Terminal blocks may incorporate surge protection devices and fuses in order to provide protection to luminaires from surges. For example, U.S. Pat. No. 9,933,147 is a prior art example that describes a terminal block assembly that includes a surge protection device and fuses. While currently available terminal blocks are functionally compliant, there are business related reasons to incorporate more features and functionality to make terminal blocks more efficient and cost-effective for incorporation into luminaires. While simple consolidation of various features and functions into a limited number of components greatly reduces time and complexity of the solution, the present invention also provides some modularity for ease of installation, which is advantageous for both factory installation and field maintenance without disturbing other aspects of the luminaire. In one embodiment, the present invention allows for pluggable surge design and other advantageous emergency, safety, and diagnostics elements.

### BRIEF DESCRIPTION OF THE DRAWINGS

In the drawings, preferred embodiments of the invention are illustrated by way of example. It is to be expressly understood that the drawings are only for the purpose of illustration and as an aid to understanding and are not intended as a definition of the limits of the invention. The embodiments herein will be understood from the following description with reference to the drawings, in which:

FIG. 1 is a perspective view of an embodiment of the exterior of the base housing unit of the terminal block;

FIG. 2 is a perspective view of an embodiment of the interior of the base housing unit of the terminal bock showing electrical connectivity components;

FIG. 3 is a perspective view of an embodiment of the exterior of the base housing unit of the terminal block, showing a fuse shorting element incorporated into the base housing unit;

FIG. 4 is a perspective view of an embodiment of the exterior of the base housing unit of the terminal block;

FIG. 5 is a perspective view of an embodiment of the exterior of the surge protection housing unit of the terminal block, showing venting ports and mechanical plugs;

FIG. 6 is a perspective view of the exterior of the surge protection housing unit of the terminal block, showing venting ports and a surge failure indicator;

FIG. 7 is a side view of an embodiment of the exterior of the surge protection housing unit of the terminal block;

FIG. 8 is a side view of an embodiment of the exterior of the surge protection housing unit of the terminal block, showing installation of the fuse shorting element and fuse;

FIG. 9 is a perspective view of an embodiment of a fuse or fuse shorting element;

FIG. 10 is a perspective view of an embodiment of a fuse or fuse shorting element and its corresponding docking port in the surge protection housing unit.

FIG. 11 is a perspective view of an embodiment of the terminal block incorporating the surge protection housing unit and the base housing unit coupled together;

FIG. 12 is a perspective view of an embodiment of a wire entry port showing a sealing mechanism incorporating a housing and grommet combination; and

FIG. 13 is a high level circuit diagram of the terminal block system.

### DETAILED DESCRIPTION OF EXAMPLE EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of art.

In one embodiment, the present invention consists of a terminal block comprised of a base housing unit 1.1 and a surge protection housing unit 5.1. When the base housing unit 1.1 and surge protection housing unit 5.1 are coupled together, the terminal block can provide electrical connectivity, surge protection, and other functionality required by an associated luminaire system or systems simultaneously.

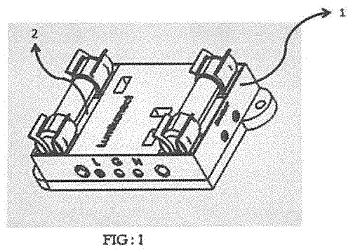

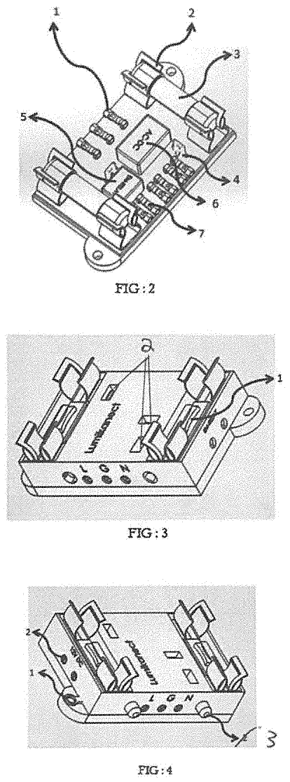

Referring to FIG. 1, one embodiment of the base housing unit 1.1 having features according to the aspects of the invention is shown. Referring to FIG. 2, one embodiment of the interior of the base housing unit is shown. The base housing unit 1.1 encases any number of components necessary to facilitate the proper electrical connectivity of an associated luminaire system or systems. The base housing unit may be comprised of any number or combination of the following components: a plurality of terminations for mains electrical supply 2.1; a plurality of luminaire-side terminations or headers 2.7; an AC to DC converter 2.6; a supply mains relay contact switch 2.5; and a fuse fault indicator 4.3. The base housing unit incorporates a grounding mechanism 4.1 that grounds the mains ground with the luminaire ground point through the use of a mounting screw or other fastening device.

The terminations 2.1, 2.7 may be any commonly known termination suitable for electrical connection. In one embodiment, the terminations 2.1, 2.7 may be push-in type terminations. In other embodiment, the terminations 2.1, 2.7 may be screw-in style terminations. In another embodiment, the luminaire-side terminations 2.7 may be replaced in part or in whole by push-in headers. In another embodiment, the luminaire-side terminations 2.7 may be comprised of a combination of different polarities to eliminate the need for additional connectors.

Referring to FIG. 12, an embodiment of a wire entry port 12.1 on the side of the base housing unit 1.1 is shown. The wire entry port 12.1 can consist of any commonly known connecting means that prevents moisture or debris from entering the base housing unit 1.1. In the embodiment of the present invention shown in FIG. 12, the wire entry port 12.1 is sealed with a grommet 12.2.

A termination port 4.2 for low voltage AC/DC power 2.6 is incorporated into the base housing unit 1.1. The DC port 4.2 can exist in a plurality of locations on the base housing unit 1.1, provided the DC port 4.2 does not interfere with any mechanical features such as the grounding mechanism 4.1 or the overall functionality of the terminal block, but preferably is located on either the front or back of the base housing unit 1.1. This AC/DC system 2.6, 4.2 can be derived from discrete or modular components.

In one embodiment, the relay contact switch 2.5, which may be implemented from discrete or module components by a person of skill in the art, is triggered by an external signal to interrupt or establish connectivity for low or high power electronic systems, including IoT systems. In one embodiment, the relay contact switch 2.5 is delayed from a few milliseconds to a second. The delayed switch provides an advantage for emergency power applications and other critical applications where stability is a crucial consideration. In one embodiment, the signal that triggers the relay contact switch 2.5 is digital. In another embodiment, the signal that triggers the relay contact switch 2.5 is analogue.

Referring to FIG. 5, an embodiment of the surge protection housing unit 5.1 having features according to the aspects of the invention is shown. The surge protection housing unit 5.1 encases surge protective components, which can be selected from any commonly known surge protection components. Extruding from the body of the surge protection housing unit 5.1 are polarity protected mechanical plugs 5.3 that dock into corresponding cut-away portions in the base housing unit 3.2 and when docked, the mechanical plugs 5.3 connect with electrical terminations 2.4 that provide an electrical connection between the electrical connectivity components of the base housing unit 1.1 and the surge protection components, fuses, and/or fuse shorting elements 9.3 in the surge protection housing unit 5.1. In some embodiments of the invention, the mechanical plugs 5.3 will incorporate locking features 5.6 that secure to the electrical terminations 2.4 to provide a secure connection between the surge protection housing unit 5.1 and the base housing unit 1.1 when coupled. In one embodiment, the locking features 5.6 will provide a low resistance connection and environmental protection.

The present invention consists of plurality of fuses or fuse shorting elements 9.3.

The number and combination of fuses or fuse shorting elements 9.3 used in any embodiment of the present invention corresponds to the particular surge protection requirements of the associated luminaire system or systems. For example, FIG. 5 displays an embodiment of the surge protection housing unit 5.1 that can accommodate two fuses or fuse shorting elements 5.2, 5.5. The fuses 9.3 incorporated in any particular embodiment of the present invention can be selected from a group consisting of any fuse that would be known to a person of skill in the art. A fuse shorting element 9.3 may be used as an alternative to a fuse when preferred. In the present invention, the fuse shorting element will behave similarly to a fuse, but will not have a current limiting feature built into it and does not interrupt the current flow in the terminal block. In one embodiment, the fuse shorting element consists of a switch. In another embodiment, the fuse shorting element consists of a push-in jumper. Referring to FIG. 3, an embodiment of a fuse shorting element is shown 3.1.

The fuse or fuse shorting element 9.3 may be encased by a locking feature 9.2 that locks into corresponding docking elements 10.3, 10.4 located on the surge protection housing unit 5.1. One embodiment of the locking feature 9.2 is a male locking feature with an extruding rectangular portion that corresponds to the size and shape of the corresponding docking port 10.3, 10.4.

The surge protection housing unit 5.1 defines cut-away portions 10.1, 10.2 to accommodate for one of more fuses or fuse shorting elements 5.2, 5.5. The cut-away portions 10.1, 10.2 contain docking ports 10.3, 10.4 that correspond with the locking elements 9.2 on fuses and fuse shorting elements 9.3. When the docking ports 10.3, 10.4 are coupled with their corresponding locking element 9.2, the fuse or fuse shorting element 5.2, 5.5 is securely fixed into the surge protection housing unit 5.1.

The base housing unit provides electrically conductive mechanical support structures 2.2 to lock fuses or fuse shorting elements 2.3 into operational position. The electrically conductive mechanical support structure 2.2 may open in a plurality of directions and may consist of a plurality of shapes and sizes to accommodate for the selected fuses or fuse shorting elements 2.3. In one embodiment, the electrically conductive mechanical support structure 2.2 opens in an upward direction to accommodate for a fuse or fuse shorting element 2.3 to attach from above the base housing unit 5.1. In another embodiment, the electrically conductive mechanical support structure 2.2 opens to either side to accommodate for a fuse or fuse shorting element 2.3 to attach from either side of the base housing unit. In another embodiment, the electrically conductive mechanical support structure 2.2 opens to on either the front or back side to accommodate for a fuse or fuse shorting element 2.3 to attach from either the front or back side of the base housing unit. The electrically conductive mechanical support structure 2.2 is of sufficient size to accommodate the corresponding fuse or fuse shorting element 2.3. The electrically conductive mechanical support structure 2.2 consists of any one of a plurality of shaped slots, selected from a group including oval, rectangular, or square slots to accommodate the corresponding shape of the corresponding fuse or fuse shorting element 2.3.

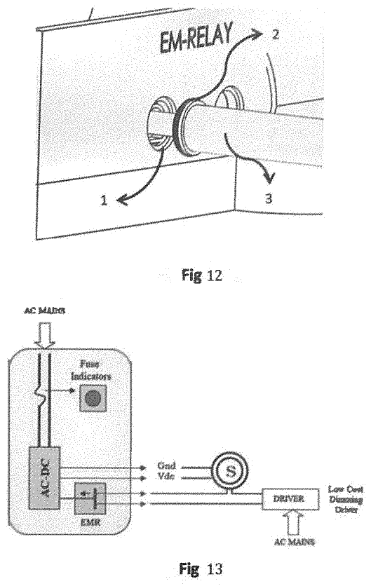

In one embodiment of the present invention, during the assembly of the terminal block, the fuse or fuse shorting element 5.2, 5.5 is secured into the docking ports 10.3, 10.4 of the surge protection housing unit 5.1 prior to being attached to the electrically conductive mechanical support structures 2.2 of the base housing unit 1.1. When the surge protection housing unit 5.1 is coupled with the base housing unit 1.1, as shown in FIG. 11, the fuse or fuse shorting element 5.2, 5.5 is locked into a docking port 10.3, 10.4 and also attached to the corresponding electrically conductive mechanical support structure 2.2. When the surge protection unit 5.1 and the base housing unit 1.1 are uncoupled from the coupled position shown in FIG. 11, the fuse or fuse shorting element 5.2, 5.5 remains locked into the docking port 10.3, 10.4 of the surge protection housing unit 5.1 and detaches from the corresponding electrically conductive mechanical support structure 2.2.

Referring to FIG. 11, an embodiment of the base housing unit 11.1 and the surge protection housing unit 11.2 coupled together is shown. When in the coupled position, the surge protection housing unit 11.2 can be detached from the base housing unit 11.1 using the extruding pull elements 7.1. The pull elements 7.1 consist of an extruded portions of the front and back of the surge protection housing unit 5.1. The pull elements 7.1 allow a user to grip the surge protection housing unit 5.1 and lift it off of the base housing unit 1.1.

When the surge protection housing unit 5.1 is detached from the base housing unit 1.1, power flow to associated luminaire systems is interrupted enabling safer conditions for users to conduct maintenance on the associated luminaire system or systems.

The present invention improves upon currently available terminal blocks by requiring only the surge protection housing unit 5.1 to be removed from the terminal block in the event of a failure of the surge protection components, fuses, or fuse shorting elements 9.2. The surge protections components, fuses or fuse shorting elements 9.2 can be easily replaced in the field by easy access due to the simple uncoupling of the base housing unit 1.1 and the surge protection unit 5.1. Additionally, the separation of the surge protection components, fuses, and/or fuse shorting elements 9.2 in the surge protection housing unit 5.1 from the remainder of components in the base housing unit 1.1 allows for easy factory installation of the terminal block components. The present invention also limits the number of components that need to be assembled within the associated luminaire.

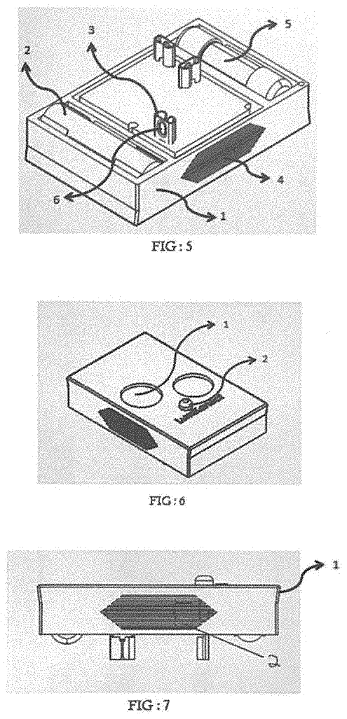

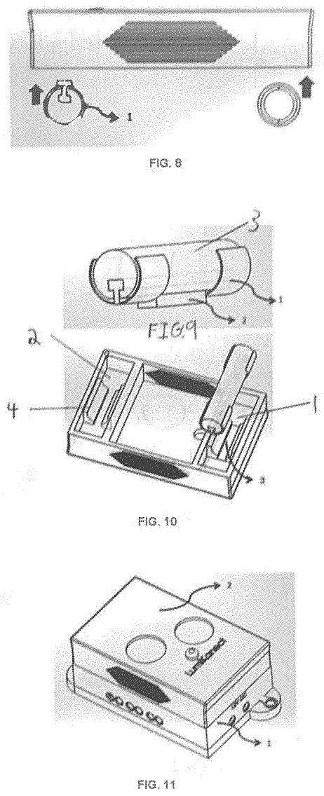

Referring to FIG. 6, an embodiment of the surge protection housing unit 5.1 with top venting ports 6.1 is shown. Referring to FIG. 7, an embodiment of the surge protection housing unit 5.1 with side venting ports 7.2 is shown. Side venting ports 7.1 are located on either side of the surge protection housing unit 5.1. The venting ports 6.1, 7.2 allow for energy and other byproducts of failure of components within the surge protection housing unit to escape into the environment to prevent or minimize damage to the terminal block and the associated luminaire system or systems. The failure of the components in the surge protection housing unit may occur as a result of a lighting surge through the terminal block. A user may determine if components of the surge protection housing unit have failed by visual examination the condition of the venting ports 6.1, 7.2, wherein a blown venting port 6.1, 7.2 signals a faulty or blown terminal block.

In one embodiment of the invention, the surge protection housing unit 5.1 is composed of material that changes colors when a surge element is blown and retains such color to alert a user that a surge element is blown.

In one embodiment of the invention, a visual indicator 6.2 provides a signal to a user that the surge elements are blown. In another embodiment, the visual indicator 6.2 is a LED.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. The apparatuses, systems and methods as described generally in the preceding description;

2. The surge immune versatile terminal block assembly described in the preceding description; and

3. Any other invention described in the preceding description.
